(19) United States
(12) Patent Application Publication
(10) Pub. No.: US 2026/0041121 A1
(43) Pub. Date: Feb. 12, 2026

(54) FEED MATRIX COMPOSITIONS

(71) Applicant: Bio-Up Mimetic Technologies, Inc., La Habra, CA (US)

(72) Inventor: Crispin G.S. Eley, Fullerton, CA (US)

(21) Appl. No.: 19/293,976

(22) Filed: Aug. 7, 2025

Related U.S. Application Data
(60) Provisional application No. 63/680,439, filed on Aug. 7, 2024.

(51) Int. Cl. A23K 20/158; A23K 50/10; A23K 50/80

(52) U.S. Cl. CPC A23K 20/158; A23K 50/10; A23K 50/80

(57) ABSTRACT

A composition includes a homogeneous mixture including lecithin, one or more triglycerides, and optionally one or more lipid soluble active ingredients. The phosphatides comprise more than 33% by weight of the homogeneous mixture. The composition further includes one or more initially dry constituents of a feed matrix onto and into which the homogeneous mixture is absorbed or adsorbed to provide a food composition suitable for animal consumption. The weight ratio of the homogeneous mixture to the one or more dry constituents of the feed matrix is up to 0.5:1.

### CROSS-REFERENCE TO RELATED APPLICATIONS

This application claims priority to and the benefit of U.S. Provisional Patent Application Ser. No. 63/680,439, filed Aug. 7, 2024, the entire content of which is incorporated herein by reference.

### BACKGROUND

The timely and efficient delivery of nutrients and diet supplements, through ingestion and digestion, is fundamental to the health of an animal. Managing the rate, extent, and timing of such delivery of nutrients and supplementary agents from a feed mixture to the alimentary tract of animals enables improvement and maintenance of the health and wellness of these animals (including humans, domestic companion animals, livestock, etc.) and can enhance, both directly and indirectly, the economic yield from, e.g., livestock farming and aquaculture. A corollary benefit, in some cases, is reduction of environmental impact of this farming.

### SUMMARY

According to embodiments of the present disclosure, a composition includes a phospholipid-rich homogeneous lipid mixture including lecithin, one or more triglycerides or their hydrolysis products, optionally one or more lipid soluble active ingredients, and optionally an alcohol at up to a 1:1 weight ratio to phosphatides. The phosphatides comprise more than 33% by weight of the lipid mixture. The composition further includes one or more initially dry constituents of a food or feed matrix onto and into which the phospholipid-rich homogeneous lipid mixture is absorbed or adsorbed to provide a food ingredient or product suitable for animal consumption. The weight ratio of the phospholipid-rich homogeneous lipid mixture to the one or more initially dry constituents of the feed matrix is up to 0.5:1.

In some embodiments, a composition includes a homogeneous mixture including lecithin, one or more triglycerides, and optionally one or more lipid soluble active ingredients. Phosphatides comprise more than 33% by weight of the homogeneous mixture. The composition further includes one or more initially dry constituents of a feed matrix onto and into which said homogeneous mixture is absorbed or adsorbed to provide a food composition suitable for animal consumption. The weight ratio of the homogeneous mixture to the one or more dry constituents of the feed matrix is up to 0.5:1.

In some embodiments, the homogenous mixture may further include a lipid soluble active ingredient extracted from a biomass by treatment with the homogenous mixture or other suitable extractants, and a biomass residue remaining after that extraction.

According to some embodiments, the homogenous mixture may further include a sterol.

In some embodiments, the composition may further include one or more additional feed constituents, and added water. And the final content of water, by weight, in the composition may be less than 15%.

According to some embodiments, the homogeneous mixture may further include a short chain alcohol suitable for animal consumption at up to 40% by weight of the total weight of the other components of the homogeneous mixture.

In some embodiments, the one or more triglycerides may include one or more animal fats produced as byproducts from animal processing; or one or more triglycerides of a plant or microbial origin. And in some embodiments, the one or more animal fats comprises fish oil, shrimp oil, or poultry oil. In some embodiments, the one or more triglycerides of a plant or microbial origin comprises canola oil, corn oil, olive oil, soybean oil, sunflower oil, safflower oil, or algal oil.

According to some embodiments, the one or more triglycerides may include a blend of triglycerides from plants, microbes, and/or animals. The blend of triglycerides may provide a selected ratio of saturated, monounsaturated, and polyunsaturated fatty acids.

In some embodiments, the composition may be tuned to provide a selected release rate of the homogenous mixture from the feed matrix in the gastrointestinal tract of the animal consuming the food composition, including by hydration within the alimentary tract, as for example by hydration, including with the aid of endogenous digestive enzymes, within the aqueous component of mucosal, gastric, or intestinal fluids.

According to some embodiments, an animal feed includes the compositions and one or more additional animal feed ingredients. In some embodiments, the composition may be formed into bars, feed pellets or other aggregates. And in some embodiments, the feed pellets or aggregates may be contained within a capsule for delivery to the gastrointestinal tract of the animal consuming the food composition. In some embodiments, the composition may be dried to remove water or alcohol from the feed. In some embodiments, the composition may include up to 18% w/w water. And in some embodiments, at least one component of the one or more initially dry constituents of the feed matrix or the one or more additional animal feed ingredients may include a soluble or fermentable fiber that is digestible in the large intestine of the animal. In some embodiments, at least one component of the one or more initially dry constituents of the feed matrix or the one or more additional animal feed ingredients may include a water-soluble material that is dissolvable in the alimentary tract of an animal.

### BRIEF DESCRIPTION OF THE DRAWINGS

The patent or application file contains at least one drawing executed in color. Copies of this patent or patent application publication with color drawings will be provided by the Office upon request and payment of the necessary fee.

The described and other features and advantages of embodiments of the present disclosure will be better understood with reference to the following detailed description when considered in conjunction with the accompanying drawings, in which:

FIG. 1 is a schematic depicting a process for the production of feed pellets according to embodiments of the present disclosure; and

FIG. 2 is a comparison of the orange-red flesh color in the salmon filets of Example 1 sacrificed at the end of the 90-day feeding period, where the orange-red flesh color was assessed both by naked eye observation and by a MINOLTA® digital color imaging system.

### DETAILED DESCRIPTION

Embodiments of the present disclosure relate to intermediate compositions, final compositions, and applications thereof for consumption by an animal. Example compositions include phosphatide-rich homogeneous mixtures of lecithin and dietary lipids, for example, triglycerides and their hydrolysis products that have a weight-based plurality of phosphatides. The compositions may also contain fat-soluble or amphiphilic agents, selected for example for improvement of animal health and wellness. The compositions according to embodiments of the present disclosure comprise combinations of such homogeneous lipid mixtures and fat-soluble agents with one or more initially dry constituents of a feed matrix.

As used herein, “animals” shall include humans, domestic companion animals and all species raised or farmed for profit, pleasure, exhibition, or competition.

A phosphatide-rich homogeneous mixture of lecithin with dietary lipids as used herein means a mixture in which the phosphatides comprise at least ⅓ by weight of said dietary lipids, at least ⅓ by weight of the combined weight of the dietary lipids and any fat-soluble agents dissolved therein, and more by weight than any alcoholic agents used for fluidizing the mixture. And in some embodiments, the phosphatides comprise at least ⅓ by weight of the combined weight of the dietary lipids, any fat-soluble agents and any alcoholic agents used for fluidizing the mixture. Aspects of embodiments of the present disclosure provide for the use of bulk food or industrial grade lecithin in a manner that is cost-effective for broad use in consumer and agricultural products, especially in applications where effective commercialization is dependent on the cost of raw materials (which precludes the use of highly purified so-called high-PC lecithin (e.g. lecithin having more than 80 w/w % of the specific phosphatide, phosphatidylcholine)).

In some embodiments, rather than ⅓ by weight as in the above-described proportions, the phosphatides may comprise at least ½ by weight of said dietary lipids, or at least ½ by weight of the combined weight of the dietary lipids and any fat-soluble agents dissolved therein. For example, in some embodiments, the ratio of phosphatides to either the dietary lipids, or the combined weight of the dietary lipids and any fat-soluble agents dissolved therein may be 6/10. If an active ingredient is provided as a 10% dispersion or solution in a triglyceride (such as corn oil) one example range of ratios for phosphatides:triglycerides:active ingredient is 350-550: 450-650: 1-100, respectively. For example, in some embodiments, a ratio of ingredients in the phosphatide-rich mixture, without fluidizing alcohol, may be approximately phosphatides:triglycerides:active ingredient 450-470: 500-530: 20-25, respectively. If a fluidizing alcohol is used, the content of the alcohol may be up to 40% by weight of the combined weight of lecithin, dietary lipids, and active ingredients when that alcohol is ethanol, and the molar equivalent thereof for other alcohols of different molecular weight. For ethanol, the alcohol may be 1%-30% w/w, or 5%-25% w/w, or less than 15% w/w, less than 10% w/w, or less than 5% w/w, and for other alcohols the molar equivalent of these amounts of ethanol may be used.

In some embodiments, the content of phosphatides may be significantly higher than 50% w/w of the lipid mixture, both with and without lipid soluble active ingredients. For example, the phosphatide content may be in the range of 40% w/w-80% w/w, 50% w/w-70% w/w, or approximately 53%-67% when the lipid soluble active ingredient is present at 0.2% w/w, 2% w/w, 5% w/w, 10-20% w/w, or 30-50% w/w, the latter of which may be particularly applicable for triglyceride active ingredients such as polyunsaturated fatty acids, for example linolenic, eicosapentaenoic and docosahexaenoic acids.

“Lecithin” as used herein means a complex mixture obtained from animal and plant sources by hydration of solvent-extract oils, as defined in the Joint World Health Organization/United Nations Food Safety Agency Evaluation Committee for Food Additives (JECFA). (Food and Agriculture Organization of the United Nations, Food and Nutrition Paper 52, “Compendium of Food Additive Specifications” (FNP 52), Addendum 2 (1993)), which is incorporated herein by reference in its entirety, and attached hereto as Appendix A. This complex mixture comprises acetone-insoluble phosphatides including predominantly phosphatidylcholine, phosphatidylethanolamine, and phosphatidylinositol, as well as smaller amounts of triglycerides, fatty acids, and carbohydrates. The present definition of lecithin, used herein, encompasses the various subsets of this mixture sold commercially in the generic category of lecithin, and includes solid, powdered, or granular, de-oiled phosphatide mixtures.

“Phosphatide(s)” as used herein means any fatty acid ester of glycerol phosphate, particularly the phospholipid components of lecithin including phosphatidylcholine, phosphatidylethanolamine, phosphatidylinositol, phosphatidic acid, phosphatidylserine, and their corresponding lysophosphatidyl derivatives.

“Dietary lipids” as used herein refer to triglycerides, and fatty acids, monoacyl- and diacyl-glycerides derived therefrom; for example, as from plants such as oils from soybeans, safflower, sunflower, coconut (and other nut), corn, olives, peanuts, rapeseed and other oils used for cooking; for example, as from animals such as anchovy, herring or similar marine oils or tallow or similar fat rendered from fowl or land animals; and for example, as extracted from microscopic organisms such as algae, bacteria or yeast. These lists provide some nonlimiting examples and are neither exhaustive nor do they exclude examples not specifically listed.

As used herein, “fat soluble or amphiphilic agent” means any compound that is selected to be, and is capable of being dissolved in the mixture of lecithin and dietary lipids, including dissolution mediated by an alcoholic plasticizing aid. For example, such agents can be lipophilic, which includes many amphiphilic compounds, as discussed in more detail below.

Lipophilic compounds are more soluble in fats, oils, lipids and organic solvents such as ethanol, methanol, ethyl ether, acetone, chloroform, and benzene than in water. Within their structure, lipophilic compounds may contain hydrophilic moieties, such as the hydroxyl group in sterols and the carboxylic acid group in long chain fatty acids. In some embodiments, lipophilic compounds have log P (logarithm of octanol:water partition coefficient) values in a range from about 0 to about 8, where the higher log P value corresponds to increased lipophilicity. In some other embodiments, the lipophilic active ingredient has a log P value ranging from about 2 to about 7. It is understood that the log P values are not limited to these ranges. For example, in some embodiments, the log P value may be greater than about 8.

As used herein, the terms “lipophilic compound(s)” and “lipophilic active ingredient(s)” are used interchangeably and refer to compounds having greater solubility in organic solvents, fats, and oils, than in water. The term “lipophilic” herein also encompasses many amphiphilic compounds, which include compounds having both hydrophobic and hydrophilic regions. Indeed, molecules may contain water-loving (hydrophilic) moieties, such as the hydroxyl group in sterols and the carboxylic acid group in long chain fatty acids. This is true for many (biologically) active species for which embodiments of this disclosure provide compositions and methods for delivery to the alimentary tract of an animal. In such cases the molecules may also be described as amphiphilic. The methods and compositions according to some embodiments of this disclosure encompass entities that may be so described and that can be dissolved in the contemplated mixture of lecithin and dietary lipid(s) and, optionally, alcoholic plasticizing aid. The lipophilic agent may also be a compound rendered fat-soluble, or amphiphilic, for example an agent created by chemical functionalization of a non-lipophilic compound with a hydrophobic group or groups, such as a derivatized nucleic acid.

The initially dry constituents of a feed matrix may include typical constituents of an animal feed selected, for example, to provide carbohydrate and protein components of balanced nutrition. Examples include, but are not limited to, crushed, ground or milled grain, bean or seed crops such as soybeans, corn, millet, oats, barley, rice and other cereal crops and pulses; protein and amino acid sources such as fish meal, feather meal, poultry meal, bone meal, blood meal, dried egg and/or dairy products (e.g., whey); and purified feed components designed to boost the level of specific nutrients such as vitamins and minerals. According to embodiments of this disclosure, the initially dry constituents may also include sources of digestible and indigestible fiber such as shredded beet or other root, lignans, cellulose, polysaccharides and cross-linked carbohydrates, and so forth, for example from bamboo or acacia or from crop or crop waste processing; and readily water-soluble ingredients such as simple salts and sugars, fructans such as inulin, and oligosaccharides. Embodiments of the present disclosure also encompass the use of inorganic dry feed components, some of which may have use as digestive or detoxifying aids for animals, such as bentonite and other clays and charcoal. Some of the initially dry ingredients may not heretofore have been used as feed ingredients for animals.

While these materials may be initially dry, embodiments of the present disclosure contemplate that such ingredients may be combined with the phosphatide-rich lecithin mixture after they have been conditioned in a process that leaves them containing a residual amount of moisture. Typical examples would be wheat, oat, or barley grains that have been steamed as part of a process to create rolled and “quick cook” cereal product ingredients.

The physical form of the initially dry feed ingredients may be varied to influence the desired rate, extent, and timing of active agent delivery in the final feed composition. These ingredients may be in the form of whole grains, seeds, or beans; crushed, ground (flour), macerated, steamed and rolled, or shredded crops or crop waste products, including bark, stem and leaves; and crystalline or amorphous powder inorganic materials of selected morphology.

According to embodiments of the present disclosure, the homogeneous mixture may be absorbed or adsorbed into or onto the initially dry constituents of the composition. For example, the homogeneous mixture may surface coat the initially dry ingredient particles, and/or be absorbed within the cavities of steam conditioned grain particles where interior voids have been opened up by steaming (or other conditioning).

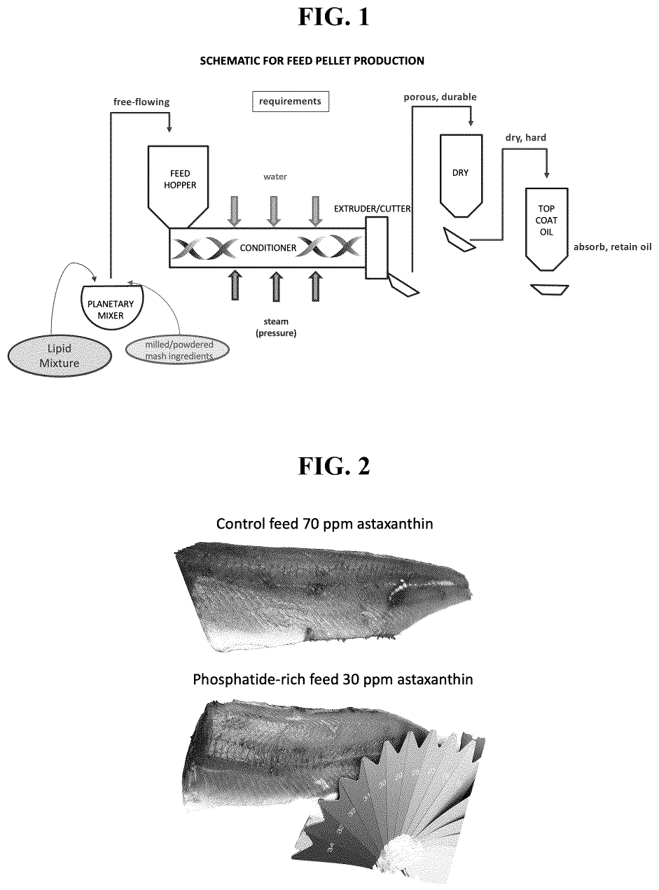

In conventional preparation of feed pellets by extrusion of a feed mash, there is an upper limit of water content above which the mash does not flow freely into the conditioner before extrusion. Likewise, the mash exiting the conditioner and entering the extruder die, having absorbed water during conditioning, will only form pellets of acceptable shape and texture for subsequent processing if the water content is below a certain threshold. It has surprisingly been found that for the compositions according to embodiments of the present disclosure, the water content may be significantly higher than the anticipated thresholds known to those of ordinary skill in the art, yet still flow freely and be extruded through the die after conditioning to yield acceptable pellets. For efficient manufacture of feed pellets, the blended dry ingredients (aka feed mash) should be gravity fed or otherwise easily conveyed to a conditioner. This typically requires that the mash is not sticky and that, in turn, limits the water content. In the conditioner the mash is transported—usually horizontally by paddle blades—through a cylinder having injection ports for steam and hot water to “condition” grains in the mash such that their pore or grain structure opens up thereby predisposing them to absorb oil in the final, later top-coating step of feed manufacture. The conditioning involves the use of water near 100 C and steam at up to 130 C. Following conditioning the transport system forces the conditioned mash through a die with circular holes under pressure and the extruded material is cut into pellets by a rotating blade. This process is shown schematically in FIG. 1.

In some embodiments, a composition includes a homogeneous mixture or a phospholipid-rich homogenous lipid mixture. The mixture includes lecithin, one or more triglycerides or their hydrolysis products, and optionally one or more lipid soluble active ingredients. In some embodiments, the mixture may further contain an alcohol at up to a 1:1 weight ratio to the phosphatides. In some embodiments, the phosphatides may be or comprise more than 33% by weight of the lipid mixture.

In some embodiments, the homogeneous mixture (also referred to herein as lipid mixture) may further include a lipid soluble active ingredient extracted from a biomass by treatment with the lecithin and triglyceride mixture and/or other suitable extractants, and the biomass residue remaining after that extraction. And in some embodiments, the lipid mixture may also contain a sterol.

In some embodiments, the triglycerides may include, comprise, consist essentially of, or consist of animal fats produced as byproducts from animal processing such as, but not limited to, fish oil, shrimp oil, poultry oil. According to some embodiments, the triglycerides may be of plant or microbial origin such as, but not limited to, canola oil, corn oil, olive oil, soybean oil, sunflower oil, safflower oil, and algal oil. And in some embodiments, a blend of triglycerides from plants, microbes, and animals may provide a selected ratio of saturated, monounsaturated, and polyunsaturated fatty acids to meet specific nutritional needs of the animals to be fed.

According to embodiments, the compositions may further include one or more initially dry constituents of a food or feed matrix onto and into which the lipid mixture is absorbed or adsorbed to provide a food ingredient, composition, or product suitable for nutrition and health support of humans, livestock, or domestic animals. In some embodiments, the weight ratio of the lipid mixture to the one or more dry constituents of the feed matrix is up to 0.5:1. In some embodiments, the compositions may further include additional feed constituents.

In some embodiments, the lipid mixture may further include an alcohol, for example, a short-chain alcohol. The alcohol may be suitable for animal consumption. The alcohol may be present in the composition at up to 40% by weight of the total weight of the other components of the lipid mixture.

In some embodiments, the compositions may include added water. According to some embodiments, for example, the final content of water, by weight, in the composition may be less than 15%, for example 3% to 12%, or 5% to 10%.

Importantly, the compositions according to embodiments of the present disclosure do not have to support the formation of stable dispersions. The stability can be very short provided it is long enough to allow for modulation of the delivery of nutrients. Crude lecithins having components other than phosphatides and triglycerides (and their hydrolysis products) often yield dispersions that are destabilized by those other components and have short shelf lives, herein designated “meta-stable dispersions.” While such crude lecithins are not suitable for application in making stand-alone products or shelf stable ingredients, they can be used in making the compositions according to embodiments of the present disclosure in which the destabilizing components do not inhibit the action of the compositions to control the rate, extent, and timing of delivery of nutrients to the alimentary tract.

According to embodiments of the present disclosure, blending and mixing at any step may be carried out by common means suitable to the characteristics of the particular mixture of ingredients concerned. The blending can occur as part of a conditioning step, for example in the conditioning in a horizontal mixer of a mash for extrusion into pellets; it may then include concurrent addition of water in liquid or steam form. Mixing may be, for example, with a planetary mixer, an immersion blender, a paddle blade mixer, a toothed-blade mixer, an in-line rotor stator mixer or other high shear processing device, a (manual) paddle or a ribbon blender. Alternative blending and mixing modalities are readily obvious to those of ordinary skill in the art, and may also be used in embodiments of the present disclosure.

There are several possible final forms of the compositions according to embodiments of the present disclosure, which in turn may be further processed into food or feed products, with or without additional ingredients. These final forms are common and well known to those of ordinary skill in the art in the area of food and feed processing and include mash, grains, paste, powder blends, slurry, pellets, bars, and so-called bites. The compositions may be subject to one or more further processing steps such as extrusion, cooking, drying, formulation into gels or smoothies, and inclusion within macroscopic delivery formats such as tablets and capsules of various sizes to be swallowed by an animal.

The lipid mixture in the compositions may be tuned to provide a selected release rate from the feed matrix of the lipid mixture in the gastrointestinal tract of the fed animal.

The amount of later-added water (e.g., water added after the homogeneous lipid mixture has been adsorbed or absorbed onto or into the initially dry constituents) in the compositions according to embodiments of the present disclosure can be selected to provide feed compositions with physical properties suited to common subsequent processing steps. As disclosed above, a range of feed mashes suitable for preparation of animal feed pellets may be readily prepared. Alternatively, a dough or paste may be made at lower amounts of water; and at high water content, a slurry may be produced suitable for use as a feed swill or for subsequent drying to a powder by common methods such as freeze drying, tray drying, or spray drying.

By delivering the fat-soluble nutrients in association with a sufficient amount of phosphatide-rich lipid mixture, the fat soluble nutrients are presented for digestive processing and uptake into the animal in a format that optimizes those processes resulting in enhanced bioavailability. Without intending to be bound by any particular theory, following ingestion of the compositions according to embodiments of the present disclosure, it is believed that the nutrients are arrayed at a phospholipid-water interface in the aqueous environment within the small intestine that is highly similar to that generated upon normal natural digestion of fat-soluble nutrients using endogenous phospholipids and bile salts for production of micelles. The adsorption on and absorption within initially dry feed ingredients modulates the formation and accessibility of such phospholipid-based interfaces for participation in alimentary tract digestive processes in the stomach, rumen, small intestine, and/or large intestine of an animal. The incorporation of active agents within the lecithin blend, particularly with a stabilizing agent such as a fat-soluble antioxidant, has also been shown to result in an unexpected improvement in retention of potency of some active agents during processing to make a feed and during storage after feed production.

Altering the relative amounts of fat-soluble agent(s), phospholipid(s) (lecithin), dietary fat(s), and initially dry feed ingredient(s) in the feed enables tuning of the rate, extent, and timing of delivery of the nutrients to the alimentary tract. The physical state of the dry feed ingredient also represents a parameter that can be varied to affect delivery. It is notable that the relative amount of lecithin required to achieve the tuning of delivery is substantially larger than that commonly used in feed and food products: the specific composition ranges identified as being effective for particular purposes are novel and unexpected.

According to embodiments of the present disclosure, an animal feed includes one of the compositions disclosed herein combined with one or more additional animal feed ingredients.

Any of the compositions or animal feeds according to embodiments of the present disclosure may be formed into bars, feed pellets or other aggregates, by extrusion or similar processing, optionally with subsequent coating, for example by, but not limited to, vacuum coating, and optionally with one or more further ingredients. The feed pellets or aggregates may be contained within a capsule for delivery to the gastrointestinal tract of an animal.

According to some embodiments, the composition may be dried to remove any later-added water (e.g., water added after the homogeneous lipid mixture has been adsorbed or absorbed onto or into the initially dry constituents, and residual moisture in those constituents from their conditioning), or alcohol from the feed. In some embodiments, the compositions may contain about up to 18% w/w water, or 2% to 15% w/w water, or 5% to 12% water in the feed pellets, aggregates, or other dry feed based matrix.

In some embodiments, at least one of the dry constituents of the feed matrix includes a soluble or fermentable fiber that is digested or digestible in the large intestine of an animal. In some embodiments, at least one of the dry constituents of the feed matrix includes a water-soluble material that dissolves or dissolvable in the alimentary tract of an animal.

Additionally, while the present disclosure discusses compositions and animal feeds for animal consumption, the present disclosure is not so limited. Indeed, the compositions and feed matrix compositions (also termed animal feeds or the like herein) can also be used for nourishment of plants, including but not limited to, via delivery of the composition or matrix composition to the plant's root ball. Other common routes suitable for nourishment of plant matter are also contemplated, including but not limited to foliar and hydroponic application.

The below Examples of embodiments of the present disclosure are presented for illustrative purposes only, and do not limit this disclosure.

Embodiments of the present disclosure encompass use of a phosphatide rich lecithin mixture prepared, for example, by combination, in a heated stainless steel vessel, of a lecithin, as needed, a fish or vegetable oil and a desirable nutrient for aquaculture or livestock feed. If a de-oiled lecithin is used, it may be desirable to add a triglyceride to achieve a desired fluidity; whereas with a crude lecithin, the triglyceride content may be sufficient without the addition of such an oil. The fluidity of the mixture also depends on the amount of water, since if low levels are chosen, the mixture may be gel- or paste-like. A low-speed paddle mixer or hand-held dough mixer is suitable for preparing a homogeneous fluid mixture from these ingredients. This mixture, while still hot, is poured into a stirred feed mash agitated by a planetary dough mixture, where the mash contains livestock or aquaculture feed ingredients, in typical proportion for the desired animal or marine organism diet, already combined at room temperature by such agitation. Following thorough blending to produce a homogeneous lecithin and nutrient fortified mash, that mash is introduced to a commercial feed pelletizer, first undergoing conditioning with steam and water, then extrusion and cutting to yield animal or marine feed pellets suitable for drying, top coating, and/or other processing. It is understood, however, that it is not necessary that all mash ingredients be present at the time the homogeneous lipid mixture is added. Instead, according to some embodiments, one or more components of the mash may be added in order to adsorb or absorb the homogeneous mixture, thereby enabling selected adsorption/absorption to specific components of the mash. The remaining ingredients may then be added after adsorption/absorption of the homogenous lipid mixture.

In some embodiments, the phosphatide content of the lecithin mixture may be as low as 33%, whereas in other embodiments the phosphatide content can be up to 80% or more; although at high phosphatide content, addition of a fluidizer, such as an alcohol, may be desired to ensure a low enough viscosity of the final mixture for facile addition to the feed mash ingredients. Such alcohols are considered safe as food ingredients, and some nonlimiting examples of such alcohols include ethanol, ethylene glycol, propylene glycol, glycerol, and so forth. The solubility of the fat-soluble agent in this fluid mixture is not readily predicted apriori but can be readily determined by those of ordinary skill in the art.

Dependent on the anticipated subsequent processing steps and the desired rate, extent, and timing of presentation of lecithin-associated nutrients to the digesting environment in the animal consuming the final product feed, the ratio of fat-soluble agent to lecithin triglyceride mixture, the lecithin content of that mixture and the weight ratio of the added lecithin blend to the mash components may be varied or tailored. That ratio of lecithin blend to mash, by weight, in some embodiments is in the range of 0.005:1 to 0.5:1, for example 0.01:1 to 0.35:1, 0.01:1 to 0.20:1, 0.01:1 to 0.1:1, 0.01:1 to 0.04:1 or 0.01:1 to 0.02:1. The specific ingredients in the mash, as well as their morphology is also an adjustable variable for modulating nutrient agent delivery to the animal. Ground meal with mesh size less than 35, less than 40, less than 45, less than 50, less than 60, less than 120, less than 230, or less than 400 mesh are examples of the grind suitable for use in embodiments of this disclosure.

Modulation of the rate, extent, and timing of delivery within the alimentary tract is of great utility. For example, such modulation can be used to improve bioavailability of nutrients in fish and other animals, optimize delivery to bacteria and other microbes in ruminants, and deliver active agents to the microbiome in the large intestine, avoiding digestive processing by the stomach and small intestine, in humans. Delivery to the large intestine, for example, provides advantages in targeting the microbiome and/or targeting (for example, for treatment) pathologies like inflammatory bowel disease (IBD), Crohn's disease, etc.

In vitro modeling has shown, for example, that proportions can be selected to facilitate the rapid generation of unexpectedly high specific surface area lecithin-based dispersions when the final product feed is exposed to water, for example water in the alimentary tract of the animal. “Specific surface area” as used herein means total surface area of dispersed phase per unit weight of dispersed phase; the specific surface area increases with decreasing average particle or droplet size. Such dispersions enhance bioavailability of otherwise hard to deliver nutritive and health benefiting agents. The plating or deposition of layers, including multiple laminate layers, of lecithin on feed matrix particle surfaces (including those surfaces within expanded grain structures) also allows for presentation of nutrients at a biomimetic phospholipid: water interface, in these cases an interface anchored to a feed matrix particle.

The proportions of the compositions according to embodiments of the present disclosure can be selected to provide feed products that—through the lecithin-blend binding to, or within, feed component particles—provide slow or staged release of lecithin based fat-soluble nutrients into an aqueous medium. This is particularly found for feed mash compositions wherein certain steamed grains are used, presumably as the grain structure is opened up by the steaming process and provides intercalation sites within the grain particles for the lecithin mixture and for aqueous lecithin-based dispersions prepared by high shear mixing of those with excess water. In this case the slow or delayed release occurs as the grain matrix itself is digested in the animal alimentary tract.

### Example 1: Astaxanthin Delivery in Aquaculture Feed Pellets

A fish feed mash of the weight composition shown in table 1 was prepared by blending the ingredients in a planetary dough mixer.

TABLE 1

| | |
|---|---|
| Fishmeal herring | 43.91% |
| L-Histidine | 0.03% |
| L-Lysine | 1.22% |
| Monosodium phosphate (23% P) | 1.24% |
| Poultry by-product | 24.33% |
| Soy protein concentrate | 1.81% |
| Vitamin C (Stay-C) | 0.36% |
| Vitamin & Mineral Premix | 0.36% |
| Wheat gluten meal | 12.14% |
| Wheat flour | 14.60% |

Separately a homogeneous phosphatide-rich mixture was prepared in a stainless steel vessel, heated to 60 C in a water bath, by combining 581 g of herring oil with 871 g of de-oiled soy lecithin (a weight ratio of 2:3), 3 g of vitamin E and 59 g of astaxanthin (synthetic, 5% in oil). Thorough mixing was accomplished with a hand-held kitchen dough mixer. 1500 grams of the mixture was added at a ratio of 2.9 w/w % to the blended feed mash components by pouring it into the dough mixer, with continuous mixing, to generate a composition with texture and flow properties suitable for use in the preparation of fish feed pellets. This composition was fed through a hopper and conditioner, therein undergoing treatment with water and steam, to an extruder with cutter blade to produce feed pellets. These pellets were dried then top coated with a blend of 20:80 canola:herring oils in a typical feed coating process familiar to those of skill in the art. The oil blend was added at a ratio of approximately 20% w:w to the dried pellets. The resulting feed contained approximately 70 ppm astaxanthin, typical of a feed used for Atlantic salmon smolt. A similar preparation was made using an oil to lecithin ratio of 1:2 and the same total of oil and lecithin. In both cases the feed pellets had appearance and texture of commercial feed. Preparations were also made using a lower addition ratio of phosphatide rich mixture to feed mash in order to generate 30 ppm astaxanthin final feed pellets. FIG. 1 schematically shows a typical fish feed manufacturing process incorporating lipid mixtures to form the compositions according to embodiments of the present disclosure.

The 2:3 ratio feed was tested in a feeding study with Atlantic salmon in freshwater tanks with fish filet color assessed after 90 days feeding (fish weight approx. 1.5 kg). The orange red color in salmon is from astaxanthin from the food chain in wild salmon and supplemented in feed pellets for farm raised fish. From conventional feed pellets it is estimated that only 10-15% of the astaxanthin is absorbed by the fish. This test used feeding with 30 ppm astaxanthin feed according to embodiments of the present disclosure and a commercial 70 ppm astaxanthin feed. The results are as shown in FIG. 2. Flesh color in filets of fish sacrificed at the end of the 90-day feeding period was assessed both by eye and by MINOLTA® digital color imaging system. There is no significant difference in color between the filets for 70 ppm control diet and the 30 ppm feed with astaxanthin incorporated using the composition according to embodiments of the present disclosure, demonstrating enhancement of nutrient (astaxanthin) delivery.

### Example 2: Bromoform Delivery in Ruminant Feed for Methanogen Inhibition

Methanogenic microbes in the rumen of cows, sheep, and goats cause the eructation of methane by these animals into the atmosphere with significant climate change impacts. Inhibiting methanogenesis, with a corollary potential gain in feed conversion ratio, is highly desirable. Several natural and synthetic compounds have been identified in previous studies as anti-methanogens, but it is known that immediate delivery and anti-methanogen activity in the rumen only provides a transient suppression of methane emission. In particular this has been found for the haloforms, for example bromoform that is naturally found in certain asparagopsis seaweeds, and for monoterpenes such as carvacrol and thymol from oregano, and also for other plant extracts. If the animal's diet is supplemented with dried seaweed or oregano, cows and sheep emit less methane.

Homogeneous phosphatide-rich lipid mixtures containing many of these compounds were each prepared by dissolving them in a heated mixture of olive or canola oil (40% w/w) and de-oiled lecithin (60% w/w). A canola oil extract, prepared using a macerate of freshly harvested asparagopsis, was also used in preparation of such a mixture. These lipid-based compositions were each suitable for blending with one or more initially dry feed ingredients. In ruminant testing, asparagopsis in animal diets suppressed methane emission from sheep, but bromoform extracted into canola oil as a diet supplement does not cause the same effect since, for this, the bolus dose of immediately bioavailable bromoform is only transiently active. In a preliminary relatively low dose study of bromoform in sheep, dried seaweed reduced animal methane emission by about 40% relative to control; phosphatide-rich lecithin and canola oil extract of the seaweed blended into feed mash yielded an approximately 20% reduction; but the canola oil extract added to feed mash itself caused only about a 5% reduction in measured methane emission. The lipid blend format provides for cost effective alternative processing, rather than expensive, rapidly implemented, drying of harvested seaweed. Optimization of lipid blend and overall feed mix composition permits improvement in the degree of methane suppression.

### Example 3: Interaction with Feed Matrix Components to Modulate Release Rate

DFSB (a \vec{D}ye Fluorescent Solvent Based dye) is a highly fluorescent fat-soluble compound that is easily visualized under UV light and widely used as a tracer for oils and organic fluids. It is an ideal compound for illustrating the interaction of the phosphatide-rich lecithin mixtures with initially dried feed matrix ingredients and blends thereof. A lipid blend of the same composition as those in Example 2 was prepared containing 0.0001 wt. % DFSB as a model for a fat-soluble nutrient or health promoting agents. This blend was added at various w/w ratios to a wide range of dry ingredients including fish meal, feather meal, soy meal, cracked wheat berries, barley, oats, arrowroot, straw, straw pellets, rolled oats, bentonite, charcoal, glucomannan, lignan, rice hulls, and chitosan. The resulting compositions were added to water and allowed to stand unstirred for up to four weeks. At various time intervals the supernatant water was examined under UV light for the presence of DFSB. In almost all cases, only very low levels of blue-white fluorescence from the lipid associated DFSB were detected, concurrently with a slight turbidity corresponding to lipid. Some representative results are summarized in Tables 2-3. These tests were repeated using triglyceride: de-oiled lecithin weight ratios of 20:80, 33:67, and 45:55 and using triglyceride-containing lecithin that had not been de-oiled. In addition, for barley, oats, steel-cut oats, and hard red spring wheat berries, a flour was produced using a bench-top grain mill operated for various milling times to produce flours of different mesh sizes (from 35 mesh to 120 mesh). These flours were compared for their ability to interact with the DFSB-containing compositions described above. Also, the exposure of grains and flours to steam before, during, and after mixing with the lipid compositions described herein was used to prepare feed compositions, and DFSB containing models thereof, to demonstrate embodiments of the present disclosure and their benefits for nutrient delivery.

TABLE 2

| | Lipid Blend Retention in Matrix |
|---|---|
| Blend alone (no matrix) | No retention |
| Charcoal | Moderate |
| Bentonite | Moderate |
| Chitosan | Moderate |
| Whole Barley | No retention |
| Ground Wheat Berry | Essentially Complete |
| Oats | Essentially Complete |
| Arrowroot | Moderate |
| Straw | No retention |
| Rice Hulls | Excellent |
| Fish meal | Excellent |
| Feather Meal | Excellent |
| Soy Meal Coarse | Moderate |
| Lignan | Excellent |
| >35mesh Barley | Essentially Complete |
| <35mesh Barley | Essentially Complete |
| 60mesh Barley | Essentially Complete |
| Glucomannan | Excellent |

Further, the feed compositions were pressed into feed pellets, with and without mixing in of additional water. The texture and performance of these feed compositions in the making of pellets by press or by extrusion was evaluated. These pellets were also evaluated by immersion in water and observation of subsequent evolution of fluorescence observed under UV light.

TABLE 3
Suitability for Making Feed Pellets by Compression

| | Lipid Blend Loading | | | | |
|---|---|---|---|---|---|
| | in Matrix at: | | | Water | Wt/wt % |
| | 5% | 10% | 12% | 15% | 20% |
| Charcoal | ✓ | ✓ | ✓ | ✓ | ∘ |
| Bentonite | ✓ | ✓ | ✓ | ✓ | ∘ |
| Chitosan | ✓ | ✓ | ✓ | ∘ | ∘ |
| Whole Barley | ✓ | ∘ | ∘ | ∘ | ∘ |
| Ground Wheat Berry | ✓ | ✓ | ✓ | ∘ | ∘ |
| Oats | ✓ | ✓ | ✓ | ∘ | ∘ |
| Arrowroot | ✓ | ✓ | ∘ | ∘ | ∘ |
| Straw | ✓ | ∘ | ∘ | ∘ | ∘ |
| Rice Hulls | ✓ | ✓ | ✓ | ✓ | ∘ |
| Fish meal | ✓ | ✓ | ✓ | ∘ | ∘ |
| Feather Meal | ✓ | ✓ | ✓ | ∘ | ∘ |
| Soy Meal Coarse | ✓ | ✓ | ∘ | ∘ | ∘ |
| Lignan | ✓ | ✓ | ∘ | ∘ | ∘ |
| >35mesh Barley | ✓ | ✓ | ✓ | ∘ | ∘ |
| <35mesh Barley | ✓ | ✓ | ✓ | ∘ | ∘ |
| 60mesh Barley | ✓ | ✓ | ✓ | ∘ | ∘ |
| Glucomannan | ✓ | ✓ | ∘ | ∘ | ∘ |

✓ = suitable
∘ = unsuitable

### Example 4: Biomass Extracted Nutrient

A composition according to embodiments of the present disclosure was also prepared with a lipid soluble active ingredient extracted from a biomass by treatment with the lecithin and triglyceride mixture and other suitable extractant, in this case propylene glycol. The composition was prepared to also contain the biomass residue remaining after that extraction, so eliminating a costly separation step normally required. 1.5 grams dried cultivated microbes having about 2% w/w astaxanthin in the dried powder was combined with shear mixing sequentially with 2.9 grams propylene glycol then 30 grams crude (triglyceride-containing) lecithin or 30 grams of a 2:3 w/w mixture of canola oil and de-oiled lecithin. After settling, a dark red homogeneous lipid mixture supernatant to a more dense mass of microbial residue was obtained in each case. Samples of these solids-containing mixtures, agitated to make them uniform, were then blended at 10% w/w with a <35 mesh milled barley flour to produce examples of compositions according to embodiments of this disclosure. These were then pressed into pellets. The very slow evolution of red coloration in the aqueous phase when such pellets were added to water demonstrates release of astaxanthin in lipid-based particles suitable for enhancing astaxanthin bioavailability.

The following example combinations are illustrative of various embodiments of the present disclosure, but do not limit the scope or content of the disclosure.

### Example Embodiment 1

A composition comprising:
a phospholipid-rich homogeneous lipid mixture comprising lecithin, one or more triglycerides or their hydrolysis products, optionally one or more lipid soluble active ingredients, and optionally further containing an alcohol at up to a 1:1 weight ratio to phosphatides,
wherein the phosphatides comprise more than 33% by weight of the lipid mixture; and
   one or more initially dry constituents of a food or feed matrix onto and into which said lipid mixture is absorbed or adsorbed to provide a food ingredient or product suitable for nutrition and health support of humans, livestock, or domestic animals,
wherein the weight ratio of the lipid mixture to the one or more dry constituents of the feed matrix is up to 0.5:1.

### Example Embodiment 2

A composition comprising:
a homogeneous mixture comprising lecithin, one or more triglycerides, and optionally one or more lipid soluble active ingredients,
wherein the phosphatides comprise more than 33% by weight of the lipid mixture; and
   one or more initially dry constituents of a feed matrix onto and into which said lipid mixture is absorbed or adsorbed to provide a food composition suitable for nutrition and health support of humans, livestock, or domestic animals,
wherein the weight ratio of the lipid mixture to the one or more dry constituents of the feed matrix is up to 0.5:1.

### Example Embodiment 3

The composition of any of example embodiments 1 to 2, wherein the lecithin and triglyceride mixture also contains both a lipid soluble active ingredient extracted from a biomass by treatment with the lecithin and triglyceride mixture or other suitable extractant and the biomass residue remaining after that extraction.

### Example Embodiment 4

The composition of any of example embodiments 1-3, wherein the lipid mixture also contains a sterol.

### Example Embodiment 5

The compositions of any of example embodiments 1-4, optionally containing additional feed constituents,
also comprising added water
   wherein
   the final content of water, by weight, in the composition is less than 15%, for example, about 3% to 12%, or about 5% to 10%.

### Example Embodiment 6

The compositions of any of example embodiments 1-5, the lipid mixture also containing a short chain alcohol suitable for animal consumption at up to 40% by weight of the total weight of the other components of the lipid mixture.

### Example Embodiment 7

The compositions of any of example embodiments 1-6, wherein the triglycerides comprise, consist essentially of, or consist of animal fats produced as byproducts from animal processing such as, but not limited to, fish oil, shrimp oil, poultry oil.

### Example Embodiment 8

The compositions of any of example embodiments 1-6, wherein the triglycerides are of plant or microbial origin such as, but not limited to, canola oil, corn oil, olive oil, soybean oil, sunflower oil, safflower oil, and algal oil.

### Example Embodiment 9

The compositions of any of example embodiments 1-6, wherein a blend of triglycerides from plants, microbes, and animals provides a selected ratio of saturated, monounsaturated, and polyunsaturated fatty acids to meet specific nutritional needs of the animals to be fed.

### Example Embodiment 10

The compositions of any of example embodiments 1-9, wherein the lipid mixture composition is tuned to provide a selected release rate from the feed matrix of a lipid mixture in the gastrointestinal tract of the fed animal.

### Example Embodiment 11

An animal feed comprising any one of example embodiments 1-10 combined with one or more additional animal feed ingredients.

### Example Embodiment 12

The compositions of example embodiment 11, formed into bars, feed pellets, or other aggregates, by extrusion or similar processing, optionally with subsequent coating, for example by, but not limited to, vacuum coating, and optionally with one or more further ingredients.

### Example Embodiment 13

The compositions of example embodiment 12, wherein the feed pellets or aggregates are contained within a capsule for delivery to the gastrointestinal tract of an animal.

### Example Embodiment 14

The compositions of any one of example embodiments 1-13 dried to remove water or alcohol from the feed.

### Example Embodiment 15

The compositions of any one of the example embodiments 1-13 containing about up to 18% w/w water, or 2% to 15% w/w water, or 5% to 12% water in the feed pellets, aggregates, or other dry feed based matrix.

### Example Embodiment 16

The compositions of any one of example embodiments 1-15, wherein at least one of the dry constituents of the feed matrix is a soluble or fermentable fiber that is digested in the large intestine of an animal.

### Example Embodiment 17

The compositions of any one of example embodiments 1-16, wherein at least one of the dry constituents of the feed matrix is a water-soluble material that dissolves in the alimentary tract of an animal.

As used herein, unless otherwise expressly specified, all numbers such as those expressing values, ranges, amounts or percentages may be read as if prefaced by the word “about,” even if the term does not expressly appear. As used herein, the terms “substantially”, “about”, and similar terms are used as terms of approximation and not as terms of degree, and are intended to account for the inherent deviations in measured or calculated values that would be recognized by those of ordinary skill in the art. Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. As used herein, the terms “combination thereof” and “combinations thereof” may refer to a chemical combination (e.g., an alloy or chemical compound), a mixture, or a laminated structure of components.

The terminology used herein is for the purpose of describing particular embodiments only and is not intended to be limiting of the present disclosure. Plural encompasses singular and vice versa. As used herein, the singular forms “a” and “an” are intended to include the plural forms as well, unless the context clearly indicates otherwise. It will be further understood that the terms “comprises”, “comprising”, “includes”, and “including,” when used in this specification, specify the presence of the stated features, integers, acts, operations, elements, and/or components, but do not preclude the presence or addition of one or more other features, integers, acts, operations, elements, components, and/or groups thereof. As used herein, the term “and/or” includes any and all combinations of one or more of the associated listed items. Expressions such as “at least one of”, when preceding a list of elements, modify the entire list of elements and do not modify the individual elements of the list.

While the subject matter of the present disclosure has been described in connection with certain embodiments, it is to be understood that the subject matter of the present disclosure is not limited to the disclosed embodiments, but, on the contrary, the present disclosure is intended to cover various modifications and equivalent arrangements included within the spirit and scope of the disclosure, and equivalents thereof.

What is claimed:

1. A composition comprising:
a phospholipid-rich homogeneous lipid mixture comprising lecithin, one or more triglycerides or their hydrolysis products, optionally one or more lipid soluble active ingredients, and optionally an alcohol at up to a 1:1 weight ratio to phosphatides, the phosphatides comprising more than 33% by weight of the phospholipid-rich homogeneous lipid mixture; and
one or more initially dry constituents of a food or feed matrix onto and into which said phospholipid-rich homogeneous lipid mixture is absorbed or adsorbed to provide a food ingredient or product suitable for animal consumption, the weight ratio of the phospholipid-rich homogeneous lipid mixture to the one or more initially dry constituents of the feed matrix being up to 0.5:1.

2. A composition comprising:
a homogeneous mixture comprising lecithin, one or more triglycerides, and optionally one or more lipid soluble active ingredients, phosphatides comprising more than 33% by weight of the lipid mixture; and
one or more initially dry constituents of a feed matrix onto and into which said homogeneous mixture is absorbed or adsorbed to provide a food composition suitable for animal consumption, the weight ratio of the lipid mixture to the one or more dry constituents of the feed matrix being up to 0.5:1.

3. The composition of claim 2, wherein the homogenous mixture further comprises:
a lipid soluble active ingredient extracted from a biomass by treatment with the homogenous mixture or other suitable extractants, and
a biomass residue remaining after that extraction.

4. The composition of claim 2, wherein the homogenous mixture further comprises a sterol.

5. The composition of claim 2, further comprising one or more additional feed constituents, and added water, the final content of water, by weight, in the composition being less than 15%.

6. The composition of claim 2, wherein the homogeneous mixture further comprises a short chain alcohol suitable for animal consumption at up to 40% by weight of the total weight of the other components of the homogeneous mixture.

7. The composition of claim 2, wherein the one or more triglycerides comprises:
one or more animal fats produced as byproducts from animal processing; or
one or more triglycerides of a plant or microbial origin.

8. The composition of claim 2, wherein:
the one or more animal fats comprises fish oil, shrimp oil, or poultry oil; or
the one or more triglycerides of a plant or microbial origin comprises canola oil, corn oil, olive oil, soybean oil, sunflower oil, safflower oil, or algal oil.

9. The composition claim 2, wherein the one or more triglycerides comprises a blend of triglycerides from plants, microbes, and/or animals, the blend of triglycerides providing a selected ratio of saturated, monounsaturated, and polyunsaturated fatty acids.

10. The composition of claim 2, wherein the composition is tuned to provide a selected release rate of the homogenous mixture from the feed matrix in the gastrointestinal tract of the animal consuming the food composition.

11. An animal feed, comprising the composition of claim 2 and one or more additional animal feed ingredients.

12. The animal feed of claim 11, wherein the composition is formed into bars, feed pellets or other aggregates.

13. The animal feed of claim 12, wherein the feed pellets or aggregates are contained within a capsule for delivery to the gastrointestinal tract of the animal consuming the food composition.

14. The animal feed of claim 11, wherein the composition is dried to remove water or alcohol from the feed.

15. The animal feed of claim 11, wherein the composition comprises up to 18% w/w water.

16. The animal feed of claim 11, wherein at least one component of the one or more initially dry constituents of the feed matrix or the one or more additional animal feed ingredients comprises a soluble or fermentable fiber that is digestible in the large intestine of the animal.

17. The animal feed of claim 11, wherein at least one component of the one or more initially dry constituents of the feed matrix or the one or more additional animal feed ingredients comprises a water-soluble material that is dissolvable in the alimentary tract of an animal.
